(19) United States
(12) Patent Application Publication
(10) Pub. No.: US 2024/0416392 A1
(43) Pub. Date: Dec. 19, 2024

(54) STEAM GENERATION SYSTEM AND STEAM APPARATUS

(71) Applicant: NEW WATT (FUJIAN) HIGH-TECH CO. LTD, Longyan (CN)

(72) Inventors: Zhaomin KE, Longyan (CN); Zhongwei ZHAO, Longyan (CN)

(21) Appl. No.: 18/821,991

(22) Filed: Aug. 30, 2024

Related U.S. Application Data
(63) Continuation of application No. PCT/CN2022/134323, filed on Nov. 25, 2022.

(30) Foreign Application Priority Data
Mar. 4, 2022 (CN) 202210206771.0
Mar. 4, 2022 (CN) 202220470764.7
Mar. 4, 2022 (CN) 202220471267.9
Mar. 4, 2022 (CN) 202220473642.3

(51) Int. Cl. B08B 3/02; F22B 37/44

(52) U.S. Cl. CPC B08B 3/026; F22B 37/44

(57) ABSTRACT

A steam generation system includes a water inlet pipe, an electromagnetic valve, a water pump, and a steam generator. The water inlet pipe is configured to convey liquid to the steam generator. The electromagnetic valve and the water pump are connected to the water inlet pipe, with the water pump providing power to drive the liquid through the water inlet pipe into the steam generator. The electromagnetic valve frequently opens and closes during operation, thereby creating a pulsed water flow into the steam generator. The steam generation system provided in this application can produce steam continuously and stably, with fast steam generation speed and controllable temperature, capable of producing high-temperature dry steam. The steam apparatus provided includes the aforementioned steam generation system.

### TECHNICAL FIELD

This application is a continuation of PCT Patent Application No. PCT/CN2022/134323, filed on 25 Nov. 2022, entitled “STEAM GENERATION SYSTEM AND STEAM APPARATUS” which claims foreign priority of Chinese Patent Application No. 202210206771.0, filed 4 Mar. 2022, Chinese Patent Application No. 202220473642.3, filed 4 Mar. 2022, Chinese Patent Application No. 202220470764.7, filed 4 Mar. 2022, and Chinese Patent Application No. 202220471267.9, filed 4 Mar. 2022 in the China National Intellectual Property Administration (CNIPA), the entire contents of which are hereby incorporated by reference in their entireties.

### TECHNICAL FIELD

This application relates to the technical field of steam apparatuses, and more particularly, to a steam generation system and steam apparatus.

### BACKGROUND OF THE INVENTION

Steam, characterized by high temperature and the ability to produce a large amount of steam from a small amount of liquid water, is advantageous in the cleaning field for its effective cleaning capabilities and water-saving properties. Prior art has seen the application of steam for cleaning in products such as steam car washers, steam mops, steam sterilizers, steam irons, steam garment steamers, and steam dishwashers.

In the prior art, steam generation is primarily achieved through boiler water storage and heating evaporation methods. The boiler, serving as a water-heating container, stores water and heats it by electric heating or fuel heating, causing the water inside to boil and produce steam. The generated steam is then output through delivery pipelines. Understandably, the components and structures at the delivery pipeline and steam outlet vary depending on the application scenario. The boiler heating method, requiring the boiling of all the water in the boiler, results in slow steam generation and difficulty in adjusting the dryness of the steam, while also exhibiting poor steam generation stability. The produced steam usually has high humidity and cannot produce dry steam, meaning it is not purely gaseous steam but rather a gas-liquid mixture with atomized liquid, rendering it unsuitable for applications requiring dry steam. Additionally, due to its gas-liquid mixture nature, the steam typically does not reach high temperatures, making it challenging to apply in situations requiring high-temperature steam.

### SUMMARY OF THE INVENTION

The present application aims to provide a steam generation system and steam apparatus designed to address, or at least partially address, the deficiencies in the prior art. This steam generation system is capable of producing steam continuously and stably, with fast steam generation speed and controllable temperature, allowing for the production of high-temperature dry steam.

The present application provides a steam generation system, including a water inlet pipe, an electromagnetic valve, a water pump, and a steam generator. The water inlet pipe is configured to convey liquid to the steam generator. The electromagnetic valve and the water pump are connected to the water inlet pipe. The water pump is configured to provide power to drive the liquid through the water inlet pipe into the steam generator. The electromagnetic valve operates with frequent on-off actions, thereby causing the liquid in the water inlet pipe to flow intermittently through the electromagnetic valve. The liquid then enters the steam generator in a pulsed flow after passing through the electromagnetic valve and the water pump.

Furthermore, the water pump is connected between the electromagnetic valve and the steam generator, with the liquid flowing through the water inlet pipe and successively passing through the electromagnetic valve and the water pump before entering the steam generator.

Furthermore, the steam generator includes a heating device. The heating device includes a heating tube and a steam pipe. Heat transfer can occur between the heating tube and the steam pipe, and the outlet of the water pump communicates with the water inlet of the steam pipe.

Furthermore, the heating device includes a heater base. The heater base is made of a thermally conductive material, with the heating tube and the steam pipe embedded within the heater base. The heating tube and the steam pipe transfer heat through the heater base.

Furthermore, the steam generator includes a temperature sensor. The temperature sensor is positioned on the heater base.

Furthermore, the temperature sensor includes a first temperature sensor and a second temperature sensor. Both of the first temperature sensor and the second temperature sensor are arranged on the heater base. The first temperature sensor and the second temperature sensor are respectively configured to detect the normal operating temperature and the shut-off protection temperature of the heating device.

Furthermore, a check valve is arranged on the pipeline between the outlet of the water pump and the inlet of the steam generator.

Furthermore, the steam generation system includes an exhaust pipe. The exhaust pipe is in communication with the water pump. An exhaust valve is arranged on the exhaust pipe.

Furthermore, the exhaust pipe is in communication with a pipeline between the outlet of the water pump and the inlet of the steam generator.

Furthermore, the steam generation system also includes a pressure relief pipeline and a pressure relief valve. A first end of the pressure relief pipeline is in communication with the outlet of the steam generator, and a second end of the pressure relief pipeline is connected to the pressure relief valve.

Furthermore, the steam generation system also includes a steam discharge pipeline. The steam discharge pipeline is in communication with the outlet of the steam generator, and a first end of the pressure relief pipeline is in communication with the steam discharge pipeline.

Furthermore, the water pump is an electromagnetic pump.

This application also provides a steam apparatus, including the above-mentioned steam generation system.

Furthermore, the steam apparatus may be one of a steam car washer, steam mop, steam sterilizer, steam iron, steam garment steamer, steam dishwasher, or steam-ozone disinfecting machine.

Furthermore, the steam apparatus also includes a housing. The steam generator and the water pump spaced apart within the housing. Ventilation holes are provided on the housing corresponding to the position of the water pump, and a fan is arranged within the housing at the position corresponding to the ventilation holes.

Furthermore, the ventilation holes include an air inlet and a first air outlet. The air inlet and the first air outlet are located on opposite sides of the housing. The fan is positioned corresponding to the air inlet.

Furthermore, heat dissipation holes are provided on the housing at the position corresponding to the steam generator.

Furthermore, a partition is arranged within the housing, separating the steam generator and the water pump.

The partition is configured to divide the interior space of the housing into a natural cooling area and a forced cooling area. The steam generator is located in the natural cooling area, and the water pump is located in the forced cooling area.

Furthermore, the steam apparatus is a steam cleaner. The steam cleaner includes a main body, a cleaning gun, and a connecting pipe. The steam generation system is housed within the main body, and the cleaning gun is in communication with the steam generation system via the connecting pipe.

Furthermore, a cleaning liquid delivery device is provided within the main body. The cleaning gun is provided with a steam nozzle and a cleaning liquid nozzle. The connecting pipe includes a steam connection pipe that connects the steam generation system to the steam nozzle, and a cleaning liquid connection pipe that connects the cleaning liquid delivery device to the cleaning liquid nozzle. The steam nozzle and the cleaning liquid nozzle are independently arranged and positioned adjacent to each other within the cleaning gun.

Furthermore, the cleaning liquid delivery device includes a delivery pump. The delivery pump is configured to extract and deliver cleaning liquid in a liquid state.

Furthermore, the cleaning liquid delivery device also includes an air pump. The air pump is configured to extract and deliver air. The connecting pipe further includes an air connection pipe. The air connection pipe is configured to connect the air pump to the cleaning liquid nozzle.

Furthermore, the cleaning gun contains a dual-fluid nozzle. The cleaning liquid connection pipe is in communication with the liquid inlet of the dual-fluid nozzle. The air connection pipe is in communication with the gas inlet of the dual-fluid nozzle. The cleaning liquid delivered by the delivery pump and the air delivered by the air pump mix within the dual-fluid nozzle and are expelled as a mist through the mixing outlet of the dual-fluid nozzle to the cleaning liquid nozzle.

Furthermore, the steam cleaner includes a high-pressure water device and a high-pressure water gun. The high-pressure water device is housed within the main body. The outlet of the high-pressure water device is in communication with the high-pressure water gun.

Furthermore, the high-pressure water device includes a high-pressure water pump. The outlet of the high-pressure water pump is in communication with the inlet of the high-pressure water gun.

Additionally, the main body includes the housing. The steam generation system, the cleaning liquid delivery device, and the high-pressure water device all are housed within the housing. The cleaning gun and the high-pressure water gun are positioned outside the housing.

Furthermore, the main body also includes a tank arranged outside the housing. The tank includes a water tank and a cleaning liquid tank. The steam generation system and the high-pressure water device are both in communication with the water tank, while the cleaning liquid delivery device is in communication with the cleaning liquid tank.

Furthermore, the housing is provided with a cleaning liquid inlet joint, a cleaning liquid outlet joint, an air outlet joint, a water inlet joint, a steam outlet joint, a high-pressure water inlet joint, and a high-pressure water outlet joint. The cleaning liquid inlet joint, the water inlet joint, and the high-pressure water inlet joint are all located on one side of the housing, while the cleaning liquid outlet joint, the steam outlet joint, the air outlet joint, and the high-pressure water outlet joint are positioned on the opposite side of the housing.

The steam generation system provided in this application features an electromagnetic valve arranged on the water inlet pipe. During operation, the steam generator is first heated to a preset temperature, and then the electromagnetic valve is controlled to open and close frequently. This causes the water in the water inlet pipe to enter the steam generator in high-frequency pulses (i.e., the water enters the steam generator in alternating strong and weak bursts). This design ensures that the water inflow into the steam generator is minimal per cycle, allowing the small amounts of water entering the high-temperature steam generator to be instantly vaporized into steam. This method of steam generation differs from the boiler boiling method in the prior art. The steam generation system does not require heating a large volume of water to boiling, thus enabling rapid steam production. Additionally, it can continuously and stably produce steam with controllable temperature, capable of generating high-temperature dry steam.

### BRIEF DESCRIPTION OF DRAWINGS

FIG. 1 is a perspective view of the steam cleaner in the embodiments according to this application.

FIG. 2 is a perspective view of the main body shown in FIG. 1.

FIG. 3 is a partial exploded view of the main body shown in FIG. 2.

FIG. 4 is a schematic diagram of the housing shown in FIG. 3.

FIG. 5 is an internal structure diagram of the main body shown in FIG. 3.

FIG. 6 is a partial exploded view of the internal structure shown in FIG. 5.

FIG. 7 is a schematic diagram from another perspective of the internal structure shown in FIG. 5.

FIG. 8 is an internal structural diagram of the cleaning gun in the embodiments according to this application.

FIG. 9 is a block diagram of the steam generation system in the embodiment according to this application.

FIG. 10 is a schematic diagram of the steam generator in the embodiment according to this application.

FIG. 11 is a cross-sectional view of the steam generator shown in FIG. 10.

FIG. 12 is a partial exploded view of the steam generator shown in FIG. 10.

FIG. 13 is an exploded view of the heating device shown in FIG. 12.

FIG. 14 is a top view of the heating tube and steam pipe shown in FIG. 13.

### DETAILED DESCRIPTION OF THE INVENTION

In conjunction with the accompanying drawings and embodiments, the specific implementation methods of this application are further described in detail. The following embodiments are provided to illustrate the application and not to limit its scope.

The terms “first,” “second,” “third,” “fourth,” etc., in the specification and claims are configured to distinguish similar objects and are not necessarily indicative of any specific order or sequence.

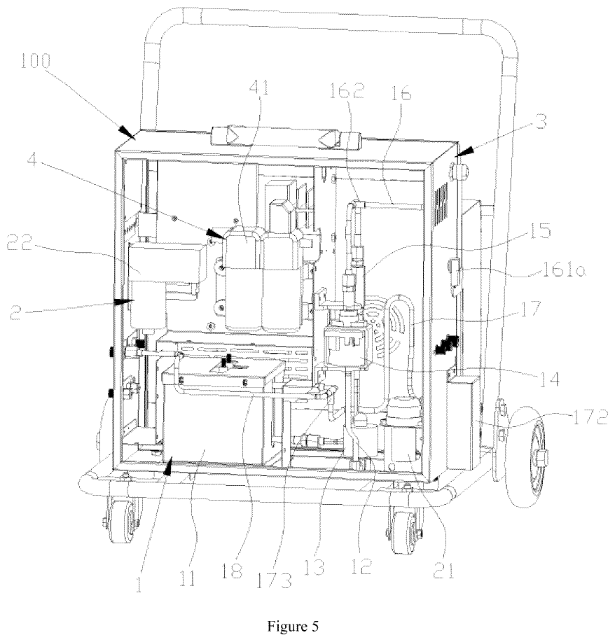

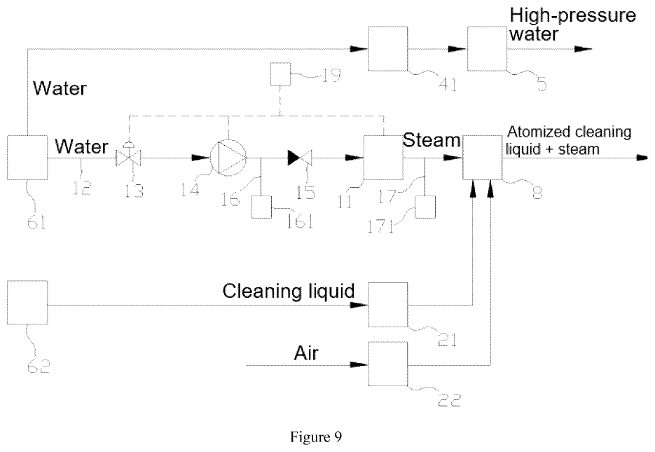

As shown in FIGS. 5 and 9, the steam generation system 1 provided in this embodiment includes a water inlet pipe 12, an electromagnetic valve 13, a water pump 14, and a steam generator 11. The water inlet pipe 12 is configured to deliver liquid to the steam generator 11. The electromagnetic valve 13 and water pump 14 are connected to the water inlet pipe 12. The water pump 14 provides power to drive the liquid through the water inlet pipe 12 into the steam generator 11. The electromagnetic valve 13 operates with frequent opening and closing actions, causing the liquid in the water inlet pipe 12 to flow intermittently through the electromagnetic valve 13. The liquid then enters the steam generator 11 in a pulsed flow after passing through the electromagnetic valve 13 and the water pump 14. This design allows the amount of liquid passing through the electromagnetic valve 13 per cycle to be minimal, yet the cycles are closely spaced, forming a micro, objectively intermittent but macroscopically continuous water flow. Since the water flow after passing through the electromagnetic valve 13 is not directly delivered to the steam generator 11, but instead passes through the pipeline and water pump 14, a preferred embodiment suggests that a proper on-off frequency can transform the intermittent water flow into a pulsed continuous flow with varying intensity after passing through the pipeline and water pump 14. This ensures continuous steam generation and prevents steam backflow. In this embodiment, the pipeline between the electromagnetic valve 13 and the water pump 14 is filled with liquid or at least has a liquid-filled section near the water pump 14. During the operation of the water pump 14, the electromagnetic valve 13 alternates between open and closed states, resulting in two alternating states of the liquid between the electromagnetic valve 13 and the water pump 14: a state where both the electromagnetic valve 13 and the water pump 14 are open, and a state where the water pump 14 is open but the electromagnetic valve 13 is closed. In the state where both the electromagnetic valve 13 and the water pump 14 are open, the liquid between the electromagnetic valve 13 and the water pump 14 flows freely, allowing the water pump 14 to discharge a certain amount of liquid towards the steam generator 11 and draw liquid from the inlet through the electromagnetic valve 13. This state creates the strong portion of the pulsed water flow. In the state where the water pump 14 is open and the electromagnetic valve 13 is closed, the upstream liquid flow is blocked, creating a closed environment between the electromagnetic valve 13 and the water pump 14. The water pump 14 must overcome negative pressure to drive the liquid towards the steam generator 11, resulting in a weaker portion of the pulsed water flow. When the electromagnetic valve 13 repeatedly opens and closes at a set frequency, the water flow from the water pump 14 to the steam generator 11 becomes a continuous pulsed flow with alternating intensity.

Furthermore, as shown in FIG. 9, the steam generation system 1 in this embodiment also includes a controller 19. The controller 19 is electrically connected to the steam generator 11, the electromagnetic valve 13, and the water pump 14 to coordinate and control the operation, opening, and closing of the steam generator 11, electromagnetic valve 13, and water pump 14.

Specifically, in this embodiment, the electromagnetic valve 13 is arranged on the water inlet pipe 12. During operation, the steam generator 11 is first heated to a preset temperature (e.g., above 200° C.). The controller 19 controls the electromagnetic valve 13 to open and close frequently, causing water in the water inlet pipe 12 to enter the steam generator 11 in high-frequency pulses (i.e., alternating strong and weak bursts of water). This ensures that the amount of water entering the steam generator 11 per cycle is minimal, allowing the small amounts of water to be instantly vaporized into steam upon entering the high-temperature steam generator 11. This method of steam generation differs from the boiler boiling method in the prior art. In one embodiment, the opening-closing frequency of the electromagnetic valve 13 is set between 50-100 Hz. This steam generation system 1 does not require heating a large volume of water to boiling, thus enabling rapid steam production. It can continuously and stably produce steam, with controllable temperature, capable of generating high-temperature dry steam.

Furthermore, as illustrated in FIGS. 5 and 9, in this embodiment, the water pump 14 is connected between the electromagnetic valve 13 and the steam generator 11. Liquid flows through the water inlet pipe 12, sequentially passing through the electromagnetic valve 13 and the water pump 14 before entering the steam generator 11. This configuration allows the water pump 14 to protect the electromagnetic valve 13 from the pressure and temperature directly transferred from the steam generator 11, thus safeguarding the electromagnetic valve 13 from potential adverse effects and ensuring its performance and longevity. By positioning the water pump 14 between the electromagnetic valve 13 and the steam generator 11 and keeping the water pump 14 continuously operating during the water intake process, the water pump 14 provides the necessary driving force for liquid flow without frequent start-stop cycles, reducing wear and tear. The electromagnetic valve 13, on the other hand, merely controls the on-off flow of water and does not provide the driving force for liquid movement. Therefore, the electromagnetic valve 13 requires minimal start-up force, making the high-frequency opening and closing of the electromagnetic valve 13 feasible.

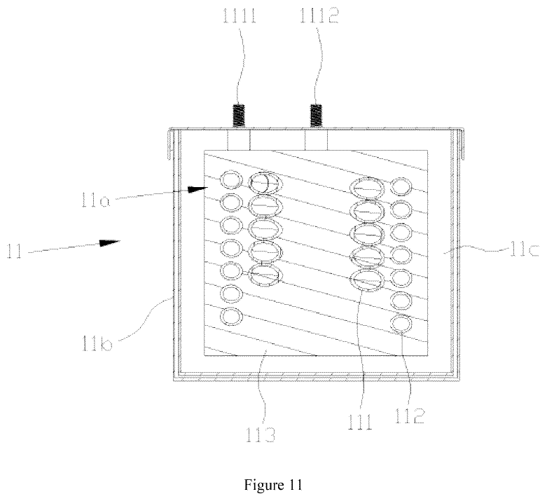

Furthermore, as shown in FIGS. 11 to 13, in this embodiment, the steam generator 11 includes a heating device 11a. The heating device 11a includes a heating tube 111 and a steam pipe 112, with heat transfer occurring between the heating tube 111 and the steam pipe 112. The outlet of the water pump 14 communicates with the water inlet of the steam pipe 112.

Furthermore, as illustrated in FIGS. 11 to 13, the heating device 11a also includes a heater base 113. The heater base 113 is made of a thermally conductive material. Both the heating tube 111 and the steam pipe 112 are embedded within the heater base 113, allowing heat transfer between them via the heater base 113. In other embodiments, heat transfer between the heating tube 111 and the steam pipe 112 can also occur through direct contact or other methods.

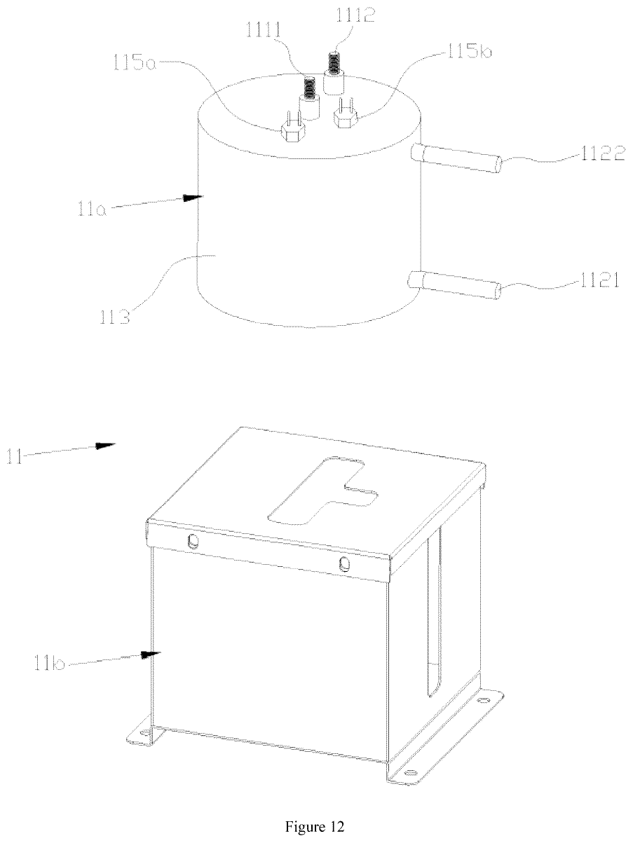

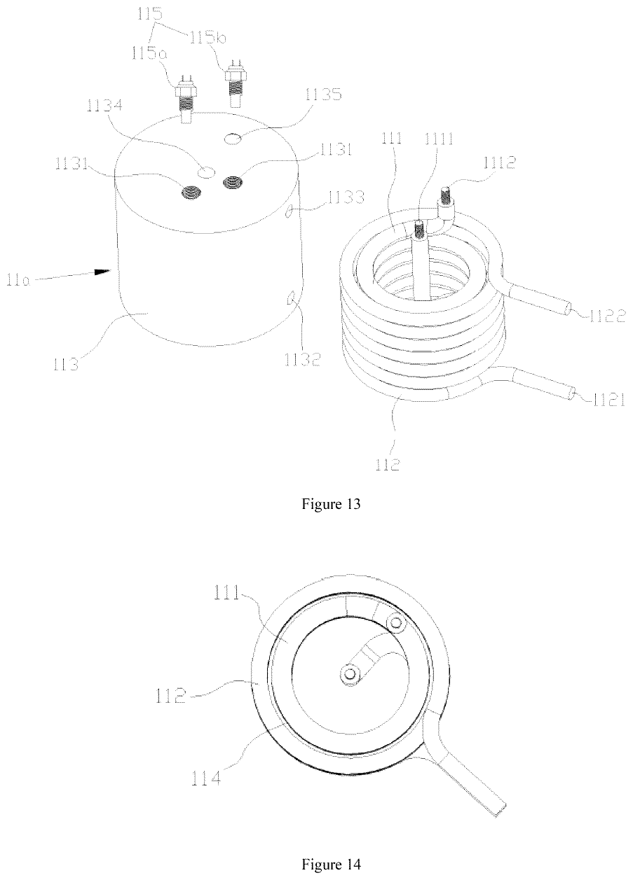

Furthermore, as shown in FIGS. 12 and 13, the steam generator 11 in this embodiment also includes a temperature sensor 115. The temperature sensor 115 is arranged on the heater base 113 and is electrically connected to the controller 19 to transmit temperature information from the heating device 11a to the controller 19.

Specifically, in this embodiment, the steam generator 11 utilizes the heater base 113 for heat transfer between the heating tube 111 and the steam pipe 112. The heat generated by the heating tube 111 is first conducted to the heater base 113, which then transfers the heat to the steam pipe 112, ensuring uniform heating and rapid temperature rise of the steam pipe 112. Since both the heating tube 111 and the steam pipe 112 are embedded within the heater base 113, there is close contact among the three components, resulting in excellent thermal conductivity and reduced heat loss during the transfer process. Additionally, the temperature sensor 115 is placed on the heater base 113 (because the heating tube 111, being the heat source, has a higher temperature than the steam, and its temperature does not represent the steam's temperature. Similarly, the temperature within the steam pipe 112 is not uniform due to the flow of water, and thus the temperature sensor 115 cannot be arranged on the heating tube 111 or the steam pipe 112, because that will cause incorrect temperature measurement) to accurately control the temperature of the steam. The steam generator 11 not only boasts high thermal conduction efficiency and fast steam generation but also ensures uniform heating of the steam pipe 112, thereby guaranteeing the quality of the generated steam (in terms of temperature uniformity and dryness). Additionally, it allows for precise control over the steam's temperature and dryness.

Specifically, in this embodiment, the heating device 11a is an electric heating device, with the heating tube 111 being an electric heating tube. The heating tube 111 has a first electrical connection terminal 1111 and a second electrical connection terminal 1112 at each end, which are connected to an external circuit to generate heat through electrical heating. The steam pipe 112 has a water inlet 1121 and a steam outlet 1122 at each end. Water enters the steam pipe 112 through the water inlet 1121, is heated to form steam, and then exits through the steam outlet 1122. During operation, when the temperature sensor 115 detects that the temperature of the heater base 113 has reached the set value, the controller 19 controls the water intake into the steam pipe 112 to generate steam. The temperature and dryness of the steam can be controlled by adjusting the set temperature value, as the steam's temperature correlates with its dryness.

Furthermore, as shown in FIGS. 12 and 13, in this embodiment, the temperature sensor 115 is positioned adjacent to the heating tube 111 and the steam pipe 112 but does not make contact with the heating tube 111 and the steam pipe 112. This placement prevents the heating tube 111 and the steam pipe 112 from affecting the temperature readings of the sensor 115.

Furthermore, as illustrated in FIG. 13, in this embodiment, the heater base 113 is provided with a mounting hole 1131. The temperature sensor 115 is arranged in the mounting hole 1131.

Furthermore, as shown in FIG. 13, the inner wall of the mounting hole 1131 is threaded, facilitating the installation of the temperature sensor 115 by allowing a threaded connection.

Furthermore, as illustrated in FIGS. 12 and 13, the temperature sensor 115 includes a first temperature sensor 115a and a second temperature sensor 115b, both arranged on the heater base 113.

Specifically, the first temperature sensor 115a and the second temperature sensor 115b are configured to detect the normal operating temperature and the shut-off protection temperature of the heating device 11a, respectively. During operation, when the first temperature sensor 115a detects that the temperature of the heater base 113 has reached the set value, the controller 19 controls the water intake into the steam pipe 112 to produce steam. By adjusting the set value, the steam's temperature and dryness can be controlled. Under normal conditions, when the first temperature sensor 115a is functioning correctly (i.e., not damaged), the temperature of the heating device 11a is regulated around the normal operating temperature, preventing overheating. However, if the first temperature sensor 115a fails to detect the temperature, the heating device 11a may continue to heat excessively, posing a safety risk. Therefore, the second temperature sensor 115b is primarily for over-temperature protection. When the second temperature sensor 115b detects a temperature reaching the shut-off protection temperature, the controller 19 stops the operation of the steam generator 11. Additionally, a visual or audible alert can be provided to notify the user of the temperature sensor failure, indicating the need for timely maintenance. The set value for the shut-off protection temperature should be higher than the normal operating temperature's set value.

Furthermore, as shown in FIG. 13, in this embodiment, the heater base 113 has two spaced mounting holes 1131. The first temperature sensor 115a and the second temperature sensor 115b are placed in the mounting holes 1131.

Furthermore, in this embodiment, the heater base 113 is formed by casting and is made of cast aluminum or cast copper.

Specifically, during manufacturing, the pre-fabricated heating tube 111 and steam pipe 112 are placed in a mold (not shown in the figures). Molten aluminum or copper is then poured or die-cast into the mold. After the aluminum or copper cools, the heater base 113 is obtained. This casting or die-casting process allows the heater base 113 to make close contact with both the heating tube 111 and the steam pipe 112, effectively encapsulating them. The use of a material with excellent thermal conductivity, such as copper or aluminum, for the heater base 113 ensures that the heat generated by the heating tube 111 is rapidly conducted to the heater base 113, which then transfers the heat to the steam pipe 112. This results in uniform heating of the steam pipe 112 and quick temperature rise while minimizing heat loss during the conduction process. Of course, in other embodiments, the heater base 113 can also be made using other manufacturing methods.

Furthermore, as shown in FIGS. 11 and 13, in this embodiment, the heating tube 111 and the steam pipe 112 are positioned close to each other within the heater base 113 to enhance the heat conduction efficiency between them.

Furthermore, as illustrated in FIG. 13, the heating tube 111 and the steam pipe 112 are both bent into spiral structures, with the heating tube 111 and the steam pipe 112 interlocking with each other.

Specifically, by configuring the heating tube 111 and the steam pipe 112 into spiral structures, the heat transfer area between the heating tube 111 and the steam pipe 112 within the heater base 113 is increased, thereby improving the heat transfer efficiency. Moreover, the interlocking arrangement of the heating tube 111 and the steam pipe 112 reduces the space occupied by these components, thus decreasing the overall size of the steam generator 11. This configuration also ensures that the heat generated by the heating tube 111 is evenly conducted to various positions along the steam pipe 112, ensuring the uniformity of the steam produced.

Furthermore, as shown in FIGS. 11 and 14, in this embodiment, the steam pipe 112 has a larger winding diameter than the heating tube 111, with the steam pipe 112 positioned around the outside of the heating tube 111. (In other embodiments, the heating tube 111 could be positioned around the outside of the steam pipe 112.) There is a gap 114 between the steam pipe 112 and the heating tube 111, which is filled with the material of the heater base 113.

Specifically, in this embodiment, the presence of the gap 114 between the steam pipe 112 and the heating tube 111 means that they do not directly contact each other for heat transfer. Instead, heat is indirectly transferred through the heater base 113. This design helps prevent uneven heating of the steam pipe 112 that could result from direct contact with the heating tube 111.

Furthermore, as shown in FIG. 13, in this embodiment, both the heating tube 111 and the steam pipe 112 have a circular tube structure, and the heater base 113 has a cylindrical shape. In other embodiments, the heater base 113 could have a rectangular or square prism shape or other configurations.

Furthermore, as illustrated in FIG. 13, a first through-hole 1132 and a second through-hole 1133 are provided on the heater base 113. The water inlet 1121 and steam outlet 1122 of the steam pipe 112 are extended through the first through-hole 1132 and the second through-hole 1133, respectively, to the outside of the heater base 113. This arrangement facilitates the connection of the steam pipe 112 to external piping systems. A first perforation 1134 and a second perforation 1135 are provided on the heater base 113. The first electrical connection terminal 1111 and the second electrical connection terminal 1112 of the heating tube 111 pass through the first perforation 1134 and the second perforation 1135, respectively, to the outside of the heater base 113. This design facilitates the connection of the heating tube 111 to external electrical circuits.

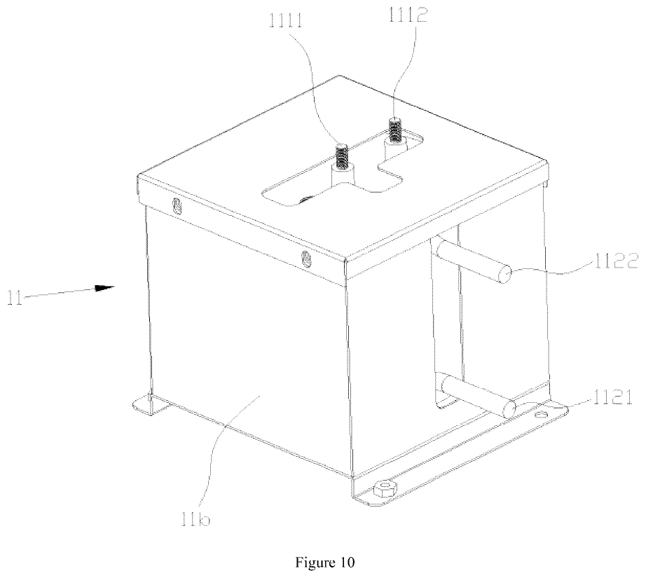

Furthermore, as shown in FIGS. 10 and 11, in this embodiment, the steam generator 11 also includes a housing 11b, with the heating device 11a situated inside the housing 11b.

Furthermore, as illustrated in FIG. 11, an insulation layer 11c is provided within the housing 11b, positioned between the outer wall of the heater base 113 and the inner wall of the housing 11b. The insulation layer 11c enhances the thermal insulation properties of the steam generator 11, reducing heat loss from inside the steam generator 11, increasing heating efficiency, and minimizing heat radiation to surrounding equipment.

In this embodiment, the insulation layer 11c is made of thermal insulation cotton, which offers high-temperature resistance, non-flammability, and low thermal conductivity at a relatively low cost. In other embodiments, the insulation layer 11c could be made from other materials such as aerogel or vacuum panels.

Furthermore, as shown in FIGS. 5, 7, and 9, in this embodiment, the steam generation system 1 includes an exhaust pipe 16. The exhaust pipe 16 is in communication with the water pump 14. An exhaust valve 161 is arranged on the exhaust pipe 16.

Specifically, during the initial operation or running of the water pump 14, air can become trapped inside the pump, a condition known as air binding. This trapped air prevents the water pump 14 from effectively drawing water, potentially hindering its normal function and, in severe cases, causing cavitation, which can damage the pump. In this embodiment, the exhaust pipe 16 connected to the water pump 14, along with the exhaust valve 161 on the exhaust pipe 16, addresses this issue. When the water pump 14 operates, opening the exhaust valve 161 allows the pump to vent air through the exhaust pipe 16, thus connecting the water pump 14 with the external environment and expelling any trapped air. This prevents the water pump 14 from air binding, ensuring its normal operation. After venting, closing the exhaust valve 161 prevents water from being expelled through the exhaust pipe 16, thus maintaining the pump's normal pumping function.

Furthermore, as shown in FIGS. 5 and 9, in this embodiment, the exhaust pipe 16 is connected to the pipeline between the outlet of the water pump 14 and the inlet of the steam generator 11. This arrangement facilitates the layout of the pipeline and the installation of the exhaust pipe 16.

Furthermore, as illustrated in FIG. 5, a first three-way valve 162 is arranged on the pipeline between the outlet of the water pump 14 and the inlet of the steam generator 11. The exhaust pipe 16 is connected to the first three-way valve 162. The exhaust pipe 16 is in communication with the pipeline between the outlet of the water pump 14 and the inlet of the steam generator 11. In other embodiments, the exhaust pipe 16 could also be welded to the pipeline between the outlet of the water pump 14 and the inlet of the steam generator 11.

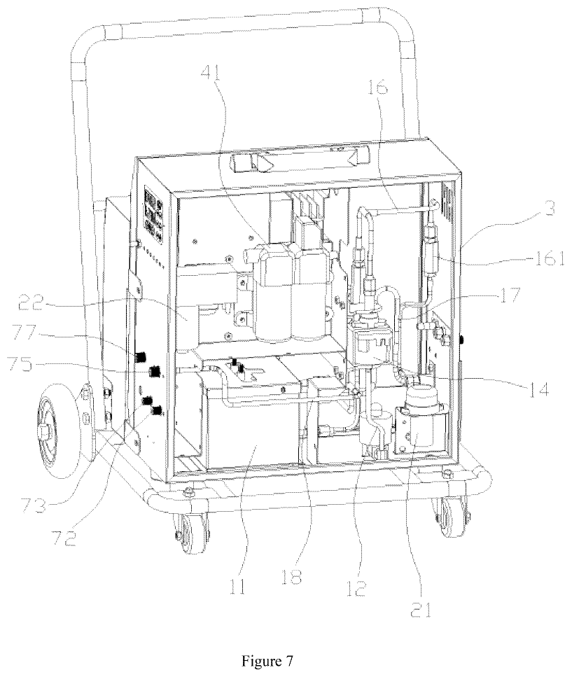

Furthermore, as shown in FIGS. 5 and 7, a knob switch 161a is provided on the exhaust valve 161. The knob switch 161a allows for the manual opening or closing of the exhaust valve 161 by turning the knob.

Furthermore, as shown in FIGS. 5 and 9, in this embodiment, a check valve 15 is arranged on the pipeline between the outlet of the water pump 14 and the inlet of the steam generator 11. This check valve 15 prevents backflow of water or steam from the steam generator 11. The exhaust pipe 16 is connected to the pipeline between the outlet of the water pump 14 and the inlet of the check valve 15. This setup ensures that when air is expelled from the water pump 14, steam is not released, thereby avoiding potential burns or startles to the user.

Furthermore, as illustrated in FIGS. 5 and 9, the steam generation system 1 includes a pressure relief pipeline 17 and a pressure relief valve 171. The first end of the pressure relief pipeline 17 is connected to the outlet of the steam generator 11, while the second end is connected to the pressure relief valve 171.

Furthermore, as shown in FIGS. 5 and 9, the steam generation system 1 also includes a steam discharge pipeline 18, which is connected to the outlet of the steam generator 11. The steam produced within the steam generator 11 can be discharged through the steam discharge pipeline 18 for user use. The first end of the pressure relief pipeline 17 is connected to the steam discharge pipeline 18, facilitating the layout and installation of the pressure relief pipeline 17.

Specifically, in this embodiment, by providing a pressure relief pipeline 17 that connects to the outlet of the steam generator 11 and the steam discharge pipeline 18, and by installing a pressure relief valve 171 on the pressure relief pipeline 17, excess steam can be released when the pressure within the steam generator 11 and steam discharge pipeline 18 becomes too high. This action opens the pressure relief valve 171, allowing the excess steam to escape through the pressure relief pipeline 17 and valve 171, thereby reducing pressure. This system helps prevent damage to components and eliminates safety risks associated with excessive pressure.

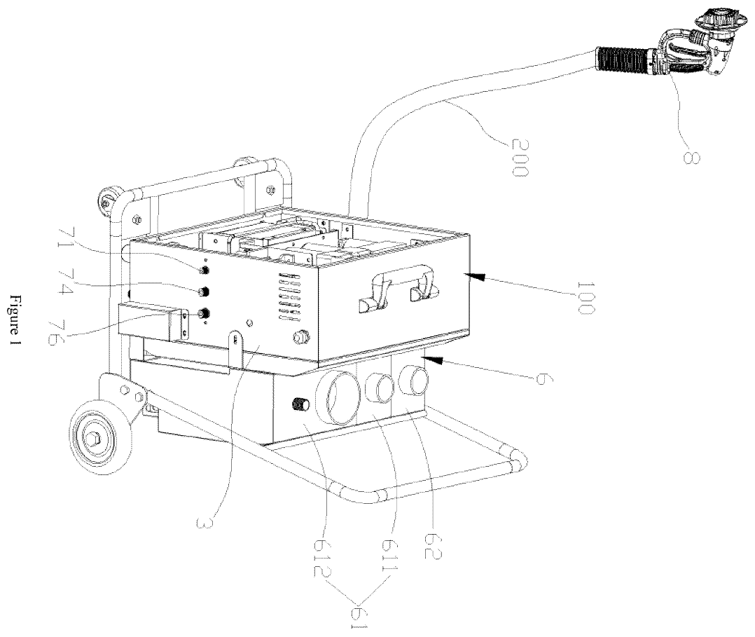

Furthermore, as shown in FIGS. 1 to 3, in this embodiment, the steam discharge pipeline 18 is provided with a second three-way valve 173. The pressure relief pipeline 17 is connected to the second three-way valve 173. The pressure relief pipeline 17 is in communication with the steam discharge pipeline 18 through the second three-way valve 173. This setup allows the pressure relief pipeline 17 to be integrated into the steam discharge system, facilitating pressure relief when needed. In other embodiments, the pressure relief pipeline 17 could also be connected to the steam discharge pipeline 18 through welding.

Furthermore, in this embodiment, the water pump 14 is an electromagnetic pump.

As shown in FIG. 1, the present application also provides a steam apparatus, which includes the aforementioned steam generation system 1. The steam apparatus can be one of a steam car washer, steam mop, steam sterilizer, steam iron, steam garment steamer, steam dishwasher, or a steam-ozone disinfection machine.

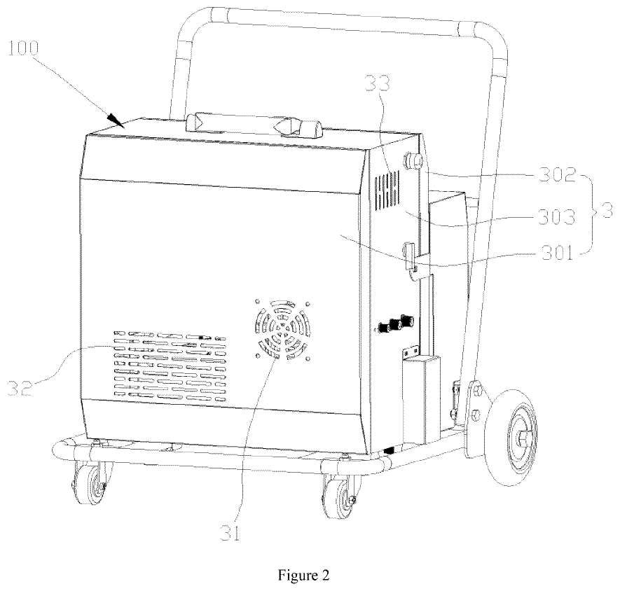

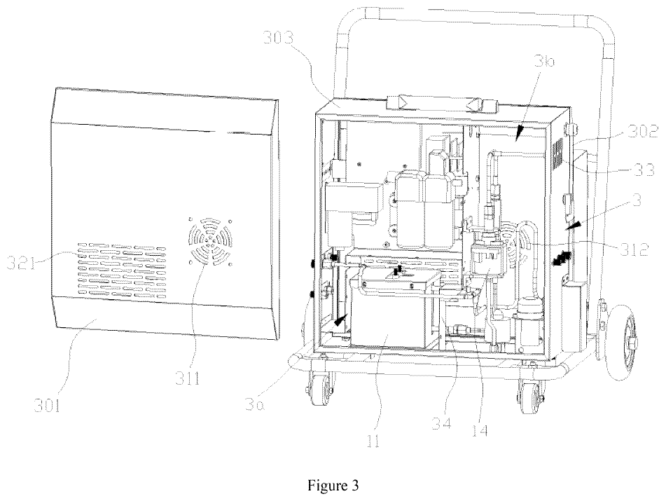

Furthermore, as illustrated in FIGS. 2 and 3, in this embodiment, the steam apparatus also includes a housing 3, with the steam generator 11 and the water pump 14 spaced apart within the housing 3. Ventilation holes 31 are provided on the housing 3 at the position corresponding to the water pump 14. Inside the housing 3, at the position corresponding to the ventilation holes 31, a fan (not shown in the figure) is arranged and fixed on the inner wall of the housing 3.

Specifically, in this embodiment, the steam apparatus includes ventilation holes 31 on the housing 3 corresponding to the location of the water pump 14, and a fan is arranged inside the housing 3 at the same position. The fan blows air to cool the water pump 14, and the dissipated heat is expelled through the ventilation holes 31. This design effectively cools the water pump 14, thereby extending its service life.

Furthermore, as shown in FIG. 3, in this embodiment, the ventilation holes 31 include an air inlet 311 and a first air outlet 312. The air inlet 311 and the first air outlet 312 are positioned on opposite sides of the housing 3, with the fan positioned corresponding to the air inlet 311.

Specifically, during cooling, air from outside the steam apparatus enters the housing 3 through the air inlet 311. The fan then blows this air over the water pump 14, cooling it down. The heated air inside the housing 3 is expelled through the first air outlet 312. This setup allows for air intake on one side of the housing and exhaust on the other side, creating a circulating airflow that effectively dissipates heat from the water pump 14, ensuring efficient cooling.

Furthermore, as shown in FIGS. 2 to 4, in this embodiment, the housing 3 includes a main body portion 303, and a front housing 301 and a rear housing 302 positioned on opposite sides of the main body portion 303. The air inlet 311 is located on the front housing 301, while the first air outlet 312 is situated on the rear housing 302. The fan is fixed to the inner wall of the front housing 301.

Specifically, this design places the air inlet 311 on the front housing 301 and the first air outlet 312 on the rear housing 302. This configuration allows air to enter from the front side of the housing and exit from the rear side, preventing hot air from blowing towards the user, thereby enhancing the user's experience.

Furthermore, as illustrated in FIGS. 2 to 4, in this embodiment, the main body portion 303 includes a second air outlet 33 to increase the exhaust area and enhance cooling efficiency.

Furthermore, as shown in FIGS. 2 and 3, cooling holes 32 are positioned on the housing 3 corresponding to the location of the steam generator 11.

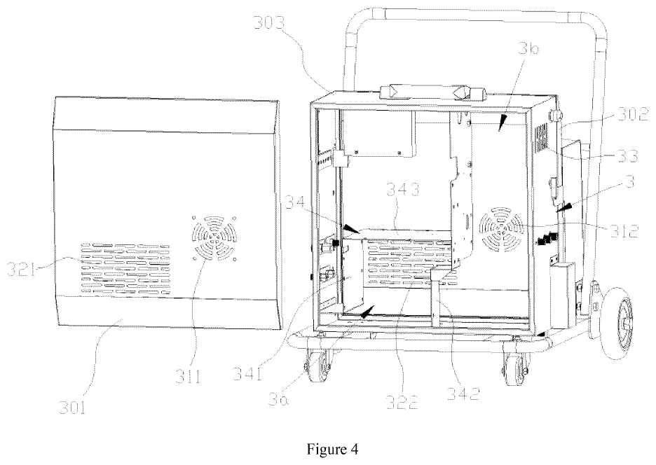

Furthermore, as illustrated in FIGS. 3 and 4, in this embodiment, the cooling holes 32 include a first cooling hole 321 and a second cooling hole 322, located on opposite sides of the housing 3. The first cooling hole 321 is on the front housing 301, while the second cooling hole 322 is on the rear housing 302.

Specifically, in this embodiment, the steam generator 11 is cooled not by a fan but through natural convection facilitated by the cooling holes 32 in the housing 3. This design avoids excessive heat loss and efficiency reduction that can occur with forced cooling methods like fans. Moreover, since the steam generator 11 has insulation measures, it emits minimal heat into the housing 3. After operation, natural convection suffices for cooling and dissipating heat.

Furthermore, as shown in FIGS. 3 and 4, in this embodiment, a partition 34 is arranged inside the housing 3, separating the steam generator 11 from the water pump 14.

Furthermore, the partition 34 divides the internal space of the housing 3 into a natural cooling area 3a and a forced cooling area 3b. The steam generator 11 is located in the natural cooling area 3a, while the water pump 14 is situated in the forced cooling area 3b.

Furthermore, as illustrated in FIGS. 3 and 4, the partition 34 surrounds the steam generator 11. It includes a first partition 341, a second partition 342, and a third partition 343. The first partition 341 and the second partition 342 are vertically arranged on the left and right sides of the steam generator 11, respectively. The third partition 343 is horizontally placed above the steam generator 11.

Specifically, this configuration, with the partition 34 separating the steam generator 11 and the water pump 14, prevents the airflow used for cooling the water pump 14 from also cooling the steam generator 11, which could lower its temperature. This design ensures that the fan-driven airflow only cools the water pump 14 and does not affect the steam generator 11. Additionally, the partition 34 helps retain heat within the steam generator 11, improving its heating efficiency and reducing heat radiation to surrounding components, including the water pump 14. This minimizes interference with the normal operation of nearby equipment.

Furthermore, as shown in FIGS. 1, 5, and 9, in this embodiment, the steam apparatus is a steam cleaner, which includes a main body 100, a cleaning gun 8, and a connecting pipe 200. The steam generation system 1 is housed within the main body 100, and the cleaning gun 8 is connected to the steam generation system 1 through the connecting pipe 200. The steam generated by the steam generator 11 can be expelled through the cleaning gun 8 for cleaning purposes.

Furthermore, as illustrated in FIGS. 1, 5, and 8, the main body 100 includes a cleaning liquid delivery device 2. The cleaning gun 8 is provided with a steam nozzle 81 and a cleaning liquid nozzle 82. The connecting pipe 200 comprises a steam connection pipe (not shown) connecting the steam generation system 1 to the steam nozzle 81, and a cleaning liquid connection pipe (not shown) connecting the cleaning liquid delivery device 2 to the cleaning liquid nozzle 82. The steam nozzle 81 and the cleaning liquid nozzle 82 are independently positioned side by side within the cleaning gun 8.

This embodiment of the steam cleaner utilizes the steam generation system 1 to produce steam and deliver it to the cleaning gun 8. Additionally, the cleaning liquid delivery device 2 delivers cleaning liquid to the cleaning gun 8, enabling the same cleaning gun 8 to spray both steam and cleaning liquid. The independent and adjacent positioning of the steam nozzle 81 and the cleaning liquid nozzle 82 allows for either separate or simultaneous spraying of steam and cleaning liquid, producing a mixed steam containing cleaning liquid. This combination of steam and cleaning liquid enhances the cleaning effect. Moreover, the ability to simultaneously spray steam and cleaning liquid with the cleaning gun 8 eliminates the need for the user to switch guns, making operation more convenient and increasing cleaning efficiency.

Specifically, in this embodiment, the cleaning gun 8 offers three operating modes: the cleaning gun 8 can spray cleaning liquid independently, steam independently, or both cleaning liquid and steam simultaneously. During use, the user can choose to spray cleaning liquid first and then steam, or vice versa, or simultaneously spray both steam and cleaning liquid. The operating mode and method of the cleaning gun 8 can be selected based on different cleaning scenarios.

Furthermore, as shown in FIGS. 5 and 9, in this embodiment, the cleaning liquid delivery device 2 includes a delivery pump 21, which is configured to extract and transport cleaning liquid in a liquid state. The outlet of the delivery pump 21 is connected to the inlet of the cleaning gun 8. In one embodiment, the cleaning liquid can be configured as a liquid fluid, either diluted from a commercially available viscous semi-fluid cleaning liquid or directly purchased as a liquid fluid. The delivery pump 21 ensures smooth flow of the cleaning liquid, reducing the risk of clogging. More importantly, the liquid form of the cleaning liquid facilitates subsequent atomization.

Furthermore, in this embodiment, the delivery pump 21 is a metering pump. Specifically, metering pumps are resistant to corrosion (suitable for transporting corrosive liquids, as many cleaning liquids have some corrosive properties) and offer precise metering and flow regulation, making them efficient for conserving cleaning liquid. Depending on the working principle, the delivery pump 21 can be a peristaltic pump or a diaphragm pump.

Furthermore, as illustrated in FIGS. 5 and 9, the cleaning liquid delivery device 2 also includes an air pump 22, which extracts and transports air. The outlet of the air pump 22 is connected to the inlet of the cleaning gun 8, allowing the cleaning liquid from the delivery pump 21 and the air from the air pump 22 to mix within the cleaning gun 8, resulting in atomized cleaning liquid. Specifically, the connecting pipe 200 also includes an air connection pipe (not shown), which connects the air pump 22 to the cleaning liquid nozzle 82.

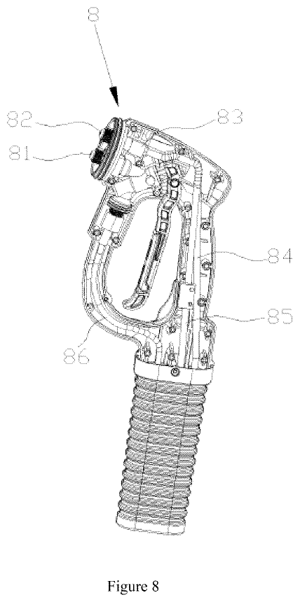

Furthermore, as shown in FIG. 8, in this embodiment, the cleaning gun 8 is provided with a dual-fluid nozzle 83. The outlet of the delivery pump 21 is connected to the liquid inlet of the dual-fluid nozzle 83 through a cleaning liquid connection pipe, while the outlet of the air pump 22 is connected to the gas inlet of the dual-fluid nozzle 83 through an air connection pipe. The delivery pump 21 and the air pump 22 respectively transport the cleaning liquid and pressurized air to the dual-fluid nozzle 83. Inside the dual-fluid nozzle 83, the cleaning liquid from the delivery pump 21 and the air from the air pump 22 mix, forming an atomized spray that exits through the mixing outlet of the dual-fluid nozzle 83 to the cleaning liquid nozzle 82.

In this embodiment, the dual-fluid nozzle 83 and the cleaning liquid nozzle 82 are separate components, connected by a threaded seal. In another embodiment, the dual-fluid nozzle 83 and the cleaning liquid nozzle 82 could be integrated, with the mixing outlet of the dual-fluid nozzle 83 directly extending to form the cleaning liquid nozzle 82.

This setup uses the air pump 22 to pressurize air, which is then delivered into the cleaning gun 8. The pressurized air disperses the cleaning liquid inside the cleaning gun 8, creating an atomized spray that is expelled through the cleaning liquid nozzle 82. This atomized cleaning liquid can be evenly sprayed onto the surface of the object to be cleaned, conserving cleaning liquid and enhancing the uniformity of the spray. Additionally, the close proximity of the steam nozzle 81 and the cleaning liquid nozzle 82 allows the atomized cleaning liquid and steam to mix evenly, further improving the cleaning effect.

Furthermore, the connecting pipe 200 can include sections located within the main body 100, inside the cleaning gun 8, and outside the main body 100 and the cleaning gun 8, connecting the two. Each connecting pipe 200 can be a continuous tube or composed of multiple segments. As shown in FIG. 8, in this embodiment, the cleaning gun 8 includes a first branch pipe 84, a second branch pipe 85, and a third branch pipe 86. The first branch pipe 84 connects the outlet of the air pump 22 to the gas inlet of the dual-fluid nozzle 83, while the second branch pipe 85 connects the outlet of the delivery pump 21 to the liquid inlet of the dual-fluid nozzle 83. The air and cleaning liquid mix after passing through the first branch pipe 84 and second branch pipe 85, respectively, creating an atomized spray that is expelled. The third branch pipe 86 connects to the outlet of the steam generator 11, allowing steam to enter and be expelled from the cleaning gun 8. The first branch pipe 84 is part of the air connection pipe, the second branch pipe 85 is part of the cleaning liquid connection pipe, and the third branch pipe 86 is part of the steam connection pipe.

Furthermore, as illustrated in FIGS. 5 and 9, this embodiment of the steam cleaner also includes a high-pressure water device 4 and a high-pressure water gun 5. The high-pressure water device 4 is housed within the main body 100, and its outlet connects to the high-pressure water gun 5, which is configured to spray high-pressure water.

This configuration allows the steam cleaner to utilize the high-pressure water device 4 to pressurize water and expel it through the high-pressure water gun 5. Consequently, the steam cleaner can simultaneously produce steam, atomized cleaning liquid, and high-pressure water for cleaning objects, achieving an effective cleaning result by combining the actions of high-pressure water, steam, and atomized cleaning liquid.

Furthermore, as shown in FIGS. 5 and 9, in this embodiment, the high-pressure water device 4 includes a high-pressure water pump 41. The outlet of the high-pressure water pump 41 is connected to the inlet of the high-pressure water gun 5. The high-pressure water pump 41 is configured to extract clean water and pressurize it to produce high-pressure water.

Furthermore, as illustrated in FIGS. 1 and 5, the main body 100 includes the housing 3, which houses the steam generation system 1, the cleaning liquid delivery device 2, and the high-pressure water device 4. The cleaning gun 8 and the high-pressure water gun 5 are positioned outside the housing 3.

Furthermore, as shown in FIGS. 1 and 9, the main body 100 also includes an external tank 6, located on one side of the housing 3. The tank 6 includes a water tank 61 and a cleaning liquid tank 62. The steam generation system 1 and the high-pressure water device 4 are connected to the water tank 61, while the cleaning liquid delivery device 2 is connected to the cleaning liquid tank 62.

Specifically, since the steam generation system 1 and the high-pressure water device 4 share the same water tank 61, this arrangement reduces the space occupied by the water tank 61 and saves material costs.

Furthermore, as illustrated in FIG. 1, in this embodiment, the water tank 61 includes two separated chambers: the first chamber 611, which is connected to the high-pressure water device 4, and the second chamber 612, which is connected to the steam generation system 1. This design allows the liquids used for the steam generation system 1 and the high-pressure water device 4 to be relatively independent. In another embodiment, the water tank 61 may consist of a single water-holding chamber, from which both the high-pressure water device 4 and the steam generation system 1 draw water, enabling high-pressure washing or steam cleaning.

Furthermore, as shown in FIGS. 1 and 7, the housing 3 is provided with a cleaning liquid inlet connector 71, a cleaning liquid outlet connector 72, an air outlet connector 73, a water inlet connector 74, a steam outlet connector 75, a high-pressure water inlet connector 76, and a high-pressure water outlet connector 77. The inlet of the delivery pump 21 is connected to the cleaning liquid inlet connector 71 via a pipeline, and the outlet of the delivery pump 21 is connected to the cleaning liquid outlet connector 72 via another pipeline. The outlet of the air pump 22 is connected to the air outlet connector 73 through a pipeline. The inlet of the water pump 14 is connected to the water inlet connector 74 via a pipeline, and the outlet of the steam generator 11 is connected to the steam outlet connector 75 via another pipeline. The inlet of the high-pressure water pump 41 is connected to the high-pressure water inlet connector 76, and the outlet of the high-pressure water pump 41 is connected to the high-pressure water outlet connector 77. The cleaning liquid inlet connector 71, water inlet connector 74, and high-pressure water inlet connector 76 are placed on one side of the housing 3, while the cleaning liquid outlet connector 72, steam outlet connector 75, air outlet connector 73, and high-pressure water outlet connector 77 are on the opposite side. By providing the cleaning liquid inlet connector 71, the cleaning liquid outlet connector 72, the air outlet connector 73, the water inlet connector 74, the steam outlet connector 75, the high-pressure water inlet connector 76, and the high-pressure water outlet connector 77 on the housing 3, the connection of external components and pipelines to the internal components of the steam cleaner is facilitated, ensuring easy and efficient setup and maintenance.

Furthermore, as shown in FIGS. 1 and 7, in this embodiment, the cleaning liquid inlet connector 71, cleaning liquid outlet connector 72, air outlet connector 73, water inlet connector 74, steam outlet connector 75, high-pressure water inlet connector 76, and high-pressure water outlet connector 77 are all threaded connectors.

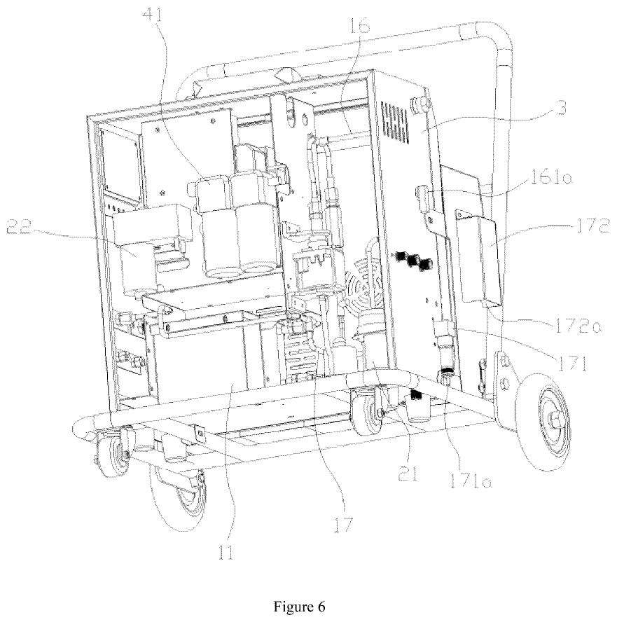

Furthermore, as illustrated in FIGS. 6 and 7, in this embodiment, the exhaust valve 161 is located inside the housing 3 and is arranged against the inner wall of the housing 3. The knob switch 161a on the exhaust valve 161 extends through the housing 3 to the outside, allowing users to easily turn the knob to open or close the exhaust valve 161.

Furthermore, as shown in FIGS. 5 to 7, in this embodiment, the pressure relief pipeline 17 is situated within the housing 3, while the pressure relief valve 171 is positioned outside the housing 3 and fixed to the housing 3. The second end of the pressure relief pipeline 17 passes through the housing 3 to connect with the pressure relief valve 171.

Furthermore, as illustrated in FIGS. 5 and 6, in this embodiment, the steam cleaner also includes a protective cover 172. The protective cover 172 is arranged outside the housing 3 and is fixed to the housing 3, covering the pressure relief valve 171. The protective cover 172 serves to protect the pressure relief valve 171 from damage due to collisions or external forces. Additionally, it shields users from potential harm caused by the release of high-temperature steam during pressure relief, preventing burns.

Furthermore, as shown in FIG. 6, in this embodiment, the exhaust port 171a of the pressure relief valve 171 is oriented downward to prevent high-temperature steam from being expelled towards the user, thereby avoiding burns during pressure relief. The bottom of the protective cover 172 has an opening 172a positioned to align with the exhaust port 171a, allowing the steam released by the pressure relief valve 171 to exit through the protective cover 172. The housing 3 has two opposite sides. The pressure relief valve 171 is located on the side of the housing 3 where the water inlet connector 74 is situated (refer to FIG. 1). The side with the steam outlet connector 75 (refer to FIG. 7) is typically where users stand during cleaning operations. By placing the pressure relief valve 171 on the opposite side, the design helps prevent steam from surprising or burning the user, enhancing safety and providing a more user-friendly experience.

The working process for generating steam in the above-described steam generation system 1 is as follows:
Heating the Steam Generator: The steam generator 11 is heated to a preset temperature.
Controlling Water Inflow: The electromagnetic valve 13 is controlled to open and close frequently, causing water in the water inlet pipe 12 to enter the steam generator 11 in high-frequency pulses. Once inside, the water is heated and vaporized into steam.

Furthermore, the temperature of the steam is controlled by adjusting the opening and closing time parameters of the electromagnetic valve 13 and/or the heating temperature parameters of the steam generator 11.

Specifically, the steam generation system 1 is provided with different settings or modes. In each mode, the parameters for the opening and closing times of the electromagnetic valve 13 and/or the heating temperature of the steam generator 11 vary, resulting in steam with different temperatures and moisture levels. The operating parameters for each mode are preset in the controller 19, which manages them through built-in programs. When the steam generator 11 is set to a lower heating temperature and/or the electromagnetic valve 13 allows more water per cycle (longer opening times, resulting in more water entering the steam generator 11 per cycle), the steam produced has higher humidity. Conversely, with a higher heating temperature and/or less water per cycle (shorter opening times), the steam has lower humidity. In this embodiment, the steam generator 11 operates at its inherent power across all modes, and the different steam humidity levels are achieved by adjusting the operating parameters of the electromagnetic valve 13. When the water inflow controlled by the electromagnetic valve 13 and the heating of the steam generator 11 reach a dynamic equilibrium of heat generation and consumption, the produced steam achieves the preset humidity for that mode, with the actual temperature of the steam generator 11 stabilizing within a certain range. This control method simplifies the process, as it does not require complex adjustments to the heating parameters of the steam generator 11, nor does it need to preset the actual temperature for dynamic balance. The control logic is straightforward, making the control process easy and reliable.

The steam generation system 1 provided in this embodiment includes an electromagnetic valve 13 arranged on the water inlet pipe 12. The controller 19 frequently opens and closes the electromagnetic valve 13, allowing water to enter the steam generator 11 in high-frequency pulses. This setup ensures that the amount of water entering the steam generator 11 per cycle is small, allowing the water to be instantly vaporized into steam upon entering the high-temperature steam generator 11. This steam generation method differs from the traditional boiler boiling method. The system eliminates the need for a boiler, thus not requiring the heating of a large volume of water to boiling. As a result, steam is generated quickly and can be produced continuously and stably, with controllable temperature and humidity levels, capable of producing high-temperature dry steam.

The description provided above is only a specific embodiment of this application. However, the scope of protection of this application is not limited to this. Any variations or replacements easily conceived by those skilled in the art within the disclosed technical scope of this application should be covered within the scope of protection of this application. The protection scope of this application should be determined by the scope of the claims.

1. A steam generation system, characterized by comprising:
a water inlet pipe (12), an electromagnetic valve (13), a water pump (14), and a steam generator (11); wherein the water inlet pipe (12) is configured to convey liquid to the steam generator (11); the electromagnetic valve (13) and the water pump (14) are connected to the water inlet pipe (12); the water pump (14) is positioned between the electromagnetic valve (13) and the steam generator (11); wherein the liquid is arranged to flow through the water inlet pipe (12), sequentially passing through the electromagnetic valve (13) and the water pump (14), before entering the steam generator (11), with the water pump (14) provides power to drive the liquid from the water inlet pipe (12) to the steam generator (11); and the electromagnetic valve (13) is configured to frequently open and close during operation, causing the liquid in the water inlet pipe (12) to pass through the electromagnetic valve (13) intermittently, and thereby creates a pulsed water flow into the steam generator (11) through the electromagnetic valve (13) and the water pump (14);
the steam generator (11) comprises a heating device (11a); the heating device (11a) comprises a heating tube (111) and a steam pipe (112) capable of heat transfer between the heating tube (111) and the steam pipe (112); an outlet of the water pump (14) is in communication with a water inlet of the steam pipe (112);
the heating device (11a) further comprises a heater base (113); the heater base (113) is made of a thermally conductive material; the heating tube (111) and the steam pipe (112) are embedded within the heater base (113) for heat transfer;
the steam generator (11) further comprises a temperature sensor (115); the temperature sensor (115) is arranged on the heater base (113).

2. The steam generation system according to claim 1, characterized in that the temperature sensor (115) comprises a first temperature sensor (115a) and a second temperature sensor (115b); both the first temperature sensor (115a) and a second temperature sensor (115b) are arranged on the heater base (113); the first temperature sensor (115a) is configured to detect a normal operating temperature, and the second temperature sensor (115b) is configured to detect a shutdown protection temperature of the heating device (11a).

3. The steam generation system according to claim 1, characterized in that a check valve (15) is arranged on the pipeline between the outlet of the water pump (14) and an inlet of the steam generator (11).

4. The steam generation system according to claim 3, characterized in that the steam generation system further comprises an exhaust pipe (16); the exhaust pipe is in communication with the water pump (14); an exhaust valve (161) is arranged on the exhaust pipe (16);
the exhaust pipe (16) is in communication with a pipeline between the outlet of the water pump (14) and the check valve (15).

5. The steam generation system according to claim 1, characterized in that the generation system further comprises a pressure relief pipeline (17) and a pressure relief valve (171); a first end of the pressure relief pipeline (17) is in communication with the outlet of the steam generator (11), and a second end of the pressure relief valve (171) is connected to the pressure relief valve (171);
the steam generation system further includes a steam discharge pipeline (18); the steam discharge pipeline (18) is in communication with the outlet of the steam generator (11); the first end of the pressure relief pipeline (17) is in communication with the steam discharge pipeline (18).

6. A steam apparatus, characterized by comprising the steam generation system (1) according to claim 1.

7. The steam apparatus according to claim 6, characterized in that the steam apparatus further comprises a housing (3); the steam generator (11) and the water pump (14) are spaced apart within the housing (3); ventilation holes (31) are provided on the housing (3) corresponding to the location of the water pump (14); and a fan is located inside the housing (3) corresponding to the ventilation holes (31);
the ventilation holes (31) comprise an air inlet (311) and a first air outlet (312); the air inlet (311) and the first air outlet (312) are located on opposite sides of the housing (3); the fan is positioned corresponding to the air inlet (311);
cooling holes (32) are provided on the housing (3) corresponding to the location of the steam generator (11).

8. The steam apparatus according to claim 7, characterized in that a partition (34) is arranged inside the housing (3), separating the steam generator (11) and the water pump (14);
the partition (34) is configured to divide an internal space of the housing (3) into a natural cooling area (3a) and a forced cooling area (3b); the steam generator (11) is located in the natural cooling area (3a), and the water pump (14) is located in the forced cooling area (3b).

9. The steam apparatus according to claim 6, characterized in that the steam apparatus is a steam cleaner; the steam cleaner comprises a main body (100), a cleaning gun (8), and a connecting pipe (200); the steam generation system (1) is housed within the main body (100), and the cleaning gun (8) is in communication with the steam generation system (1) through the connecting pipe (200).

10. The steam apparatus according to claim 9, characterized in that the main body (100) comprises a cleaning liquid delivery device (2); a steam nozzle (81) and a cleaning liquid nozzle (82) is provided within the cleaning gun (8); the connecting pipe (200) comprises a steam connection pipe connecting the steam generation system (1) to the steam nozzle (81), and a cleaning liquid connection pipe connecting the cleaning liquid delivery device (2) to the cleaning liquid nozzle (82); the steam nozzle (81) and the cleaning liquid nozzle (82) are positioned independently and adjacently within the cleaning gun (8);
the cleaning liquid delivery device (2) comprises a delivery pump (21) for extracting and delivering cleaning liquid in a liquid state;
the cleaning liquid delivery device (2) further comprises an air pump (22) for extracting and delivering air; the connecting pipe (200) comprises an air connection pipe connecting the air pump (22) to the cleaning liquid nozzle (82).

11. The steam apparatus according to claim 10, characterized in that the cleaning gun (8) comprises a dual-fluid nozzle (83); the cleaning liquid connection pipe is in communication with a liquid inlet of the dual-fluid nozzle (83); the air connection pipe is in communication with a gas inlet of the dual-fluid nozzle (83); the cleaning liquid from the delivery pump (21) and the air from the air pump (22) are allowed to mix within the dual-fluid nozzle (83), and expelled as an atomized spray from the dual-fluid nozzle (83) to the cleaning liquid nozzle (82).

12. The steam apparatus according to claim 10, characterized in that the steam cleaner further comprises a high-pressure water device (4) and a high-pressure water gun (5); the high-pressure water device (4) is housed within the main body (100), and an outlet of the high-pressure water device (4) is in communication with the high-pressure water gun (5);
the high-pressure water device (4) comprises a high-pressure water pump (41); an outlet of the high-pressure water pump (41) is in communication with an inlet of the high-pressure water gun (5).

13. The steam apparatus according to claim 12, characterized in that the main body (100) comprises the housing (3); the steam generation system (1), the cleaning liquid delivery device (2), and the high-pressure water device (4) are housed within the housing (3); the cleaning gun (8) and the high-pressure water gun (5) are positioned outside the housing (3);
the main body (100) also comprises an external tank (6) located outside the housing (3); the tank (6) comprises a water tank (61) and a cleaning liquid tank (62); both the steam generation system (1) and the high-pressure water device (4) are in communication with the water tank (61); the cleaning liquid delivery device (2) is in communication with the cleaning liquid tank (62).

14. The steam apparatus according to claim 13, characterized in that the housing (3) is provided with a cleaning liquid inlet connector (71), a cleaning liquid outlet connector (72), an air outlet connector (73), a water inlet connector (74), a steam outlet connector (75), a high-pressure water inlet connector (76), and a high-pressure water outlet connector (77); the cleaning liquid inlet connector (71), water inlet connector (74), and high-pressure water inlet connector (76) are positioned on one side of the housing (3); and the cleaning liquid outlet connector (72), steam outlet connector (75), air outlet connector (73), and high-pressure water outlet connector (77) are positioned on the opposite side.
